(19) United States
(12) Patent Application Publication
(10) Pub. No.: US 2025/0221382 A1
(43) Pub. Date: Jul. 10, 2025

(54) SAFETY PET LEASH

(71) Applicant: Jennifer Velasquez Morse, San Clemente, CA (US)

(72) Inventor: Jennifer Velasquez Morse, San Clemente, CA (US)

(21) Appl. No.: 18/922,380

(22) Filed: Oct. 21, 2024

Related U.S. Application Data
(60) Provisional application No. 63/545,040, filed on Oct. 20, 2023.

(51) Int. Cl. A01K 27/00

(52) U.S. Cl. CPC A01K 27/004

(57) ABSTRACT

A pet leash has a housing with an interior space, the housing having a graspable member adapted to be grasped by a handler. A lead extends from a pet connecting member to a housing end, the housing end of the lead being received within the interior space of the housing. A lead retraction mechanism is associated with the housing and adapted to allow the lead to be retracted into the housing or extended from the housing, and a retraction control mechanism is adapted to control the lead retraction mechanism to allow a handler to selectively control the retraction into and extension from the housing of the lead to selectively adjust the length of the lead extending from the housing. A safety locking mechanism is adapted to be in an unactuated position and in an actuated position where the safety locking mechanism prevents extension of the lead from the housing.

### PRIORITY

The present application claims the benefit of domestic priority based on U.S. Provisional Patent Application 63/545,040 filed on Oct. 20, 2024, the entirety of which is incorporated herein by reference.

### BACKGROUND

Pet leashes, especially retractable dog leashes, are useful for allowing pet owners to walk their dog or other pet while allowing the pet some autonomy. However, it is important that the dog or other pet is maintained under the owner's control, and that is sometimes a problem with currently available retractable leashes.

With a conventional retractable dog leash, a graspable housing contains a spring-loaded spool on which is contained a lead, also known as a rope, tape, cord, belt, or the like, which can be of various shapes and styles, that has an end connectable to a pet to be walked. The spool can wind and unwind by action of the pet and/or a handler that is walking the pet. Typically, the conventional retractable pet leash includes a control button or buttons on the top of the housing. The control button or buttons can include a brake and/or a lock that slows and/or locks the winding or unwinding of the spool. By controlling the spool, the handler can select a mode of operation of the retractable leash so that the length of extended cord and/or the speed of winding or unwinding can be adjusted.

However, conventional retractable pet leash braking and locking mechanisms have exhibited vulnerabilities when subjected to the strain of powerful pets, such as large and/or active dogs. This is particularly problematic for pet owners with energetic and/or reactive dogs that are prone to sudden bursts of forceful movements, leading to potential safety risks and challenges in maintaining control during walks. Existing retractable leash locking systems fail to adequately secure strong dogs, thereby posing risks to the animal's safety and the safety of others in the vicinity. Pet owners often encounter situations where the existing locking mechanism proves insufficient in containing the force generated by the animal, causing the leash to detach or release suddenly, potentially leading to accidents or injuries. As a result, many pet owners choose to avoid the risk of using a retractable leash with some pets.

Attempts have been made to help alleviate the problem of lunging dogs. For example, automatic braking mechanisms have been disclosed that operate automatically when there is a quick lunge in a manner similar to the way a seatbelt works in a vehicle. The automatic braking mechanisms are designed to prevent a lunge when one occurs unexpectedly, but they do not solve the problem of preventing the lunge of a powerful dog. Typically, the automatic braking mechanism is even more delicate than the conventional brake or lock

There is therefore a need for an improved pet leash. There is further a need for an improved retractable pet leash. There is a further need for a retractable pet leash with an improved locking mechanism. There is a further need for a retractable pet leash with a secondary, safely locking mechanism, especially useful with large and/or active dogs.

### SUMMARY

The present invention satisfies one or more of these needs. In one aspect of the invention, an improved pet leash is provided.

In another aspect of the invention, an improved retractable pet leash is provided.

In another aspect of the invention, a retractable leash is provided with an improved locking mechanism.

In another aspect of the invention, a retractable pet leash has a secondary safety locking mechanism.

In another aspect of the invention, a pet leash is provided with a safety locking mechanism that is manually activated.

In another aspect of the invention, a pet leash is provided with a safety locking mechanism that is manually activated and deactivated.

In another aspect of the invention, a pet leash is provided a retraction mechanism that includes a locking feature, wherein the pet leash further comprises an additional safety locking mechanism.

In another aspect of the invention, a pet leash is provided a retraction mechanism that includes a locking feature, wherein the pet leash further comprises a safety locking mechanism that is manually activated independently of the locking feature.

In another aspect of the invention, a pet leash is provided a retraction mechanism that includes a locking feature, wherein the pet leash further comprises a safety locking mechanism that is manually activated independently of the locking feature and manually deactivated independently of the locking feature.

In another aspect of the invention, a pet leash is provided a retraction mechanism that includes a locking feature, wherein the pet leash further comprises a safety locking mechanism, the safety locking mechanism being activated by a button on the side of a casing of the pet leash.

In another aspect of the invention, a method of walking a pet comprises providing a safety pet leash as described herein and using the safety pet leash as described herein.

In another aspect of the invention, pet leash comprises a housing comprising sidewalls, a bottom, and a top that define an interior space, the housing having a graspable member adapted to be grasped by a handler; a lead comprising a length of material extending from a pet connecting member to a housing end of the lead, the housing end of the lead being received within the interior space of the housing; a lead retraction mechanism associated with the housing and adapted to allow the lead to be retracted into the housing or extended from the housing; a retraction control mechanism adapted to control the lead retraction mechanism to allow a handler to selectively control the retraction into and extension from the housing of the lead to selectively adjust the length of the lead extending from the housing; and a safety locking mechanism associated with the housing and adapted to be in an unactuated position where the lead retraction mechanism operates under the control of the retraction control mechanism and in an actuated position where the safety locking mechanism prevents extension of the lead from the housing.

In another aspect of the invention, a pet leash comprises a housing comprising sidewalls, a bottom, and a top that define an interior space, the housing having a graspable member adapted to be grasped by a handler; a lead comprising a length of material extending from a pet connecting member to a housing end of the lead, the housing end of the lead being received within the interior space of the housing; a lead retraction mechanism associated with the housing and adapted to allow the lead to be retracted into the housing or extended from the housing, the lead retraction mechanism comprising a spooling mechanism, the spooling mechanism comprising: a spool member that is rotatable about a spool axis, the spool member having a lead receiving channel adapted to receive the lead in a spooling manner, and a spring adapted to bias the rotating spool member in a rotational direction that retracts the lead into the housing, and a safety locking mechanism associated with the housing and adapted to be in an unactuated position where the lead can be extended from the housing and in an actuated position where the safety locking mechanism prevents of the lead from being extended from the housing, wherein the safety locking mechanism comprises an actuator moveable relative to the housing in a direction parallel to the spool axis to cause the safety locking mechanism to move from the unactuated position to the actuated position.

In another aspect of the invention, a method of walking a pet on a leash comprises providing a pet leash comprising a housing comprising sidewalls, a bottom, and a top that define an interior space, the housing having a graspable member adapted to be grasped by a handler; a lead comprising a length of material extending from a pet connecting member to a housing end of the lead, the housing end of the lead being received within the interior space of the housing; a lead retraction mechanism associated with the housing and adapted to allow the lead to be retracted into the housing or extended from the housing; a retraction control mechanism adapted to control the lead retraction mechanism to allow a handler to selectively control the retraction into and extension from the housing of the lead to selectively adjust the length of the lead extending from the housing; and a safety locking mechanism associated with the housing and adapted to be in an unactuated position where the lead retraction mechanism operates under the control of the retraction control mechanism and in an actuated position where the safety locking mechanism prevents extension of the lead from the housing, connecting the pet connecting member to a pet to be walked; grasping the graspable member of the housing; operating the retraction control mechanism to select a length of lead to extend from the housing; and when desired, actuating the safety locking mechanism to prevent further extension of the lead from the housing.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic perspective view from the right side and rear of a version of a pet leash according to the invention;

FIG. 2A is a schematic perspective view from the right side and rear of the pet leash of FIG. 1 with a safety locking mechanism in an unactuated position;

FIG. 2B is a schematic perspective view from the right side and rear of the pet leash of FIG. 1 with a safety locking mechanism in an actuated position;

FIG. 3A is a schematic left side view of another version of a pet leash of the invention with a safety locking mechanism in an unactuated position;

FIG. 3B is a schematic rear view of the pet leash of FIG. 3A with a safety locking mechanism in an unactuated position;

FIG. 3C is a schematic rear view of the pet leash of FIG. 3A with a safety locking mechanism in an actuated position;

FIG. 4A is a schematic perspective view from the right side and rear of a version of a pet leash of the invention with a portion of a housing removed;

FIG. 4B is a schematic perspective view from the right side and front of a version of an actuator of the pet leash of FIG. 4A;

FIG. 5A is a schematic sectional view of a portion of the pet leash of FIGS. 4A and 4B with a safety locking mechanism in an unactuated position;

FIG. 5B is a schematic sectional view of a portion of the pet leash of FIGS. 4A and 4B with a safety locking mechanism in an actuated position;

FIG. 6A is a schematic perspective view from the right side and rear of a version of a pet leash of the invention with a portion of a housing removed;

FIG. 6B is a schematic perspective view from the right side and front of a version of an actuator of the pet leash of FIG. 6A;

FIG. 7 is a schematic sectional view of a portion of the pet leash of FIGS. 6A and 6B with a safety locking mechanism in an actuated position;

FIG. 8 is a schematic perspective view from the rear and left of a portion of the pet leash of FIGS. 6A and 6B;

FIG. 9 is a schematic perspective exploded view of the components of the pet leash of FIGS. 6A and 6B;

FIG. 10 is a schematic sectional view of the pet leash of FIGS. 6A and 6B;

FIG. 11A is a schematic perspective view from the front and left of a portion of another version of a pet leash of the invention with a safety locking mechanism in an unactuated position;

FIG. 11B is a schematic perspective view from the front and left of the portion of the pet leash of FIG. 11A with a safety locking mechanism in an actuated position;

FIG. 12A is a schematic perspective view from the right side and rear of a version of a pet leash of the invention with a portion of a housing removed; and

FIG. 12B is a schematic perspective view from the right side and front of a version of an actuator of the pet leash of FIG. 12A.

### DESCRIPTION

The present invention relates to a pet leash with a safety locking mechanism. In particular, the invention relates to a retractable pet leash with a safety locking mechanism. Although the invention is illustrated and described in the context of being useful for retractable dog leashes, the present invention can be useful in other instances. Accordingly, the present invention is not intended to be limited to the examples and embodiments described herein.

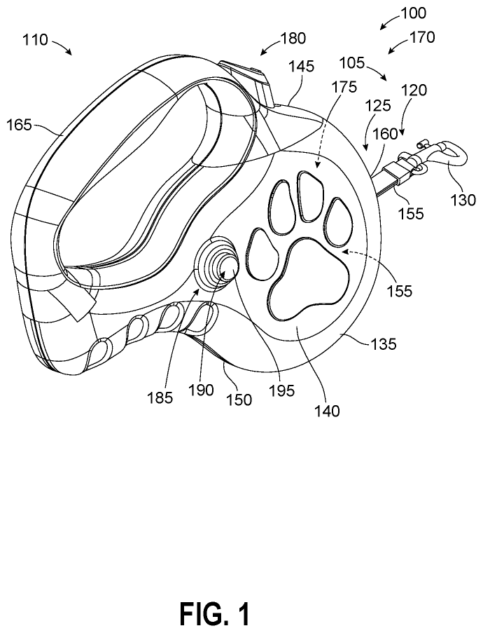

FIG. 1 shows a version of a pet leash 100 in accordance with the present invention. The pet leash includes a pet tethering portion 105 and a handler portion 110 connected to the pet tethering portion 105. The pet tethering portion 105 includes a lead 115 extending from a pet end 120 to a handler end 125. The lead 115, which is also commonly referred to as a rope, tape, cord, belt, and the like, is a length of at least partially flexible material that can take any of several different forms and/or shapes. For example, the lead 115 can be flat or round or a combination of being flat along a portion of its length and round along another portion of its length. The pet end 120 of the lead 115 is connectable to a pet to be walked or that needs to be otherwise controlled or retrained. While the pet to be walked or controlled will often be a dog that is to be walked by the pet's handler, such as an owner, caregiver, or assistant, by pet it is meant any animal that is to be walked or restrained whether or not the animal is owned or controlled by the pet walker and whether or not the animal is living, mechanical, robotic, or otherwise. The pet end 120 of the lead 115 includes a pet connecting member 130, such as a hook, snap clip, carabiner clip, other type of clasp, or the like as is conventionally known for connecting the pet end 120 of the lead 115 to the pet to be walked, such as by connecting the hook 130 to the pet's collar or harness. At the handler end 125 of the lead 115, which is opposite the pet end 120, the lead 115 is connected to a housing 135. The housing 135 includes a sidewall 140, top wall 145, and bottom wall 150 that together define an interior space 155 within the housing 135. The interior space 155 is sized and shaped to store at least a portion of the lead 115 of the pet tethering portion 105. A lead opening 160 is provided in the housing 135, for example in the front of the housing 135, through which the lead 115 can extend so that at least the pet end 120 of the lead 115 is positioned outside the housing 135. Optionally, the lead opening 160 can be sized or shaped so that the pet connecting member 130 or other portion of the pet end 120 of the lead 115 is blocked from being pulled into the interior space 155 of the housing 135. The housing 135 also includes a graspable member 165, such as a handle, that is sized, shaped, and optionally contoured to receive a hand or other body part of a handler during use. Accordingly, in use with a pet connected to the lead 115 by the pet connecting member 130, a handler is able to grasp the graspable member 165 of the housing 135 in order to control the pet.

In the version of FIG. 1, the pet leash 100 is in the form of a retractable pet leash 170 with a lead retraction mechanism 175 associated with the housing 135. The lead retraction mechanism 175 selectively winds and/or unwinds the handler end 125 of the pet tethering portion 105 within the housing 135 in order to control the length of the lead 115 that extends from the lead opening 160 to the pet connecting member 130 and thus to a pet that is connected to the pet connecting member 130. A retraction control mechanism 180 is provided to allow the handler to control the operation of the lead retraction mechanism 175. The retraction control mechanism 180 includes one or more buttons 185 that can selectively cause or allow the lead retraction mechanism 175 wind, unwind, brake, and/or lock. The one or more buttons 185 are positioned on the top 145 of the housing 135 in proximity to the graspable member 165 so that a handler that is grasping the housing 135 can easily access the one or more buttons 185 with their thumb or other body part. The lead retraction mechanism 175 and retraction control mechanism 180 are conventionally known in the art in various forms and are described for example in German Patent DE 200 19 939; U.S. Pat. Nos. 6,694,922; 7,896,218, 8,528,850; and/or U.S. Pat. No. 9,439,400, all of which are incorporated herein by reference in their entireties.

The pet leash 100 of the version of FIG. 1 also includes a safety locking mechanism 185. The safety locking mechanism 185 is designed for and adapted to prevent the unwinding and/or winding of the lead 115 by the lead retraction mechanism 180 when the safety locking mechanism 185 is actuated or activated. In the version of FIG. 1, the safety locking mechanism 185 operates independently of, in place of, and/or in addition to the retraction control mechanism 180. Accordingly, the safety locking mechanism 185 can be actuated in whatever position the retraction control mechanism 180 is in. Thus, the safety locking mechanism 185 can operate as the sole lock when a locking feature of the retraction control mechanism 180 is not present or is disengaged or can operate as an additional lock when a locking feature of the retraction control mechanism 185 is engaged. In the version of FIG. 1, the safety locking mechanism 185 is actuated by an actuator 190. In one version, the actuator is a manual actuator that is manually actuated and/or unactuated by the handler. For example, in the particular version shown, the actuator 190 comprises a button 195 or the like that can be pressed or otherwise manually actuated. In the version shown, the actuator 190 is spaced from the retraction control mechanism 180 to help facilitate the independent operation of each of the mechanisms. Alternatively, the button 195 or other type of actuator 190 and the retraction control mechanism 180 can be more closely positioned.

The safety locking mechanism 185 of the pet leash 100 is provided to make the pet leash 100 safer and/or more controllable than a pet leash 100 that lacks a safety locking mechanism 185. In this regard, the safety locking mechanism 185 is an improved and/or an additional manner of locking the extension and/or retraction of the lead 115 from the housing 135. In one version in which the safety locking mechanism 185 is provided in addition to a locking feature in the retraction control mechanism 180, the safety locking mechanism 185 can be considered analogous to an emergency brake or hand brake for a vehicle. Much like the vehicle can be stopped by a foot brake and/or locked by a parking brake, the vehicle can be additionally and/or more securely prevented from moving by the application of an emergency brake or hand brake. This additional safety locking mechanism can be an extra security measure that help to prevent a pet from running away from the handler in the event of the lead retraction mechanism 175 and/or the retraction control mechanism 180 breaking, malfunctioning, or being improperly used, thus helping to avoid a safety hazard to the pet and others. This can be particularly important when large and/or highly active or reactive pets are being walked, as such pets can pull with sufficient force to break conventional locking and/or braking features of retraction control mechanism 180.

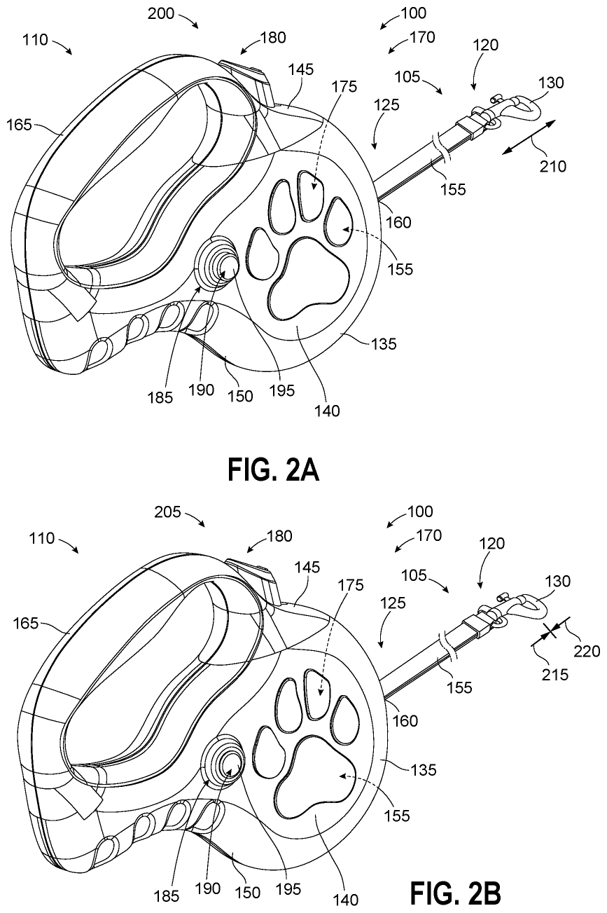

FIGS. 2A and 2B show the pet leash 100 of FIG. 1 with the safety locking mechanism 185 in different states of operation. FIG. 2A shows the pet leash 100 with its safety locking mechanism 185 in an unactuated position 200, whereas FIG. 2B shows the pet leash 100 with its safety locking mechanism 185 in an actuated position 205. When in the unactuated position 200 of FIG. 2A, the lead 115 is free to be extended and retracted under the normal operation of the lead retraction mechanism 175 and control of the retraction control mechanism 180, as indicated by arrow 210. In this particular version, when in the unactuated position 200, the button 195 of the actuator 190 is not depressed and extends outwardly from the sidewall 140 of the housing 135. By depressing the button 195, as shown in FIG. 2B, the safety locking mechanism 185 is moved to its actuated position 205. When in the actuated position 205, the safety locking mechanism 185 stops the extension of the lead 115 relative to the housing 135 instantly, as indicated by arrow 215. Optionally, the safety locking mechanism 185 can also prevent retraction of the lead, as indicated by arrow 220. When the safety locking mechanism 185 is in the unactuated position 200, the pet leash can be used in a normal manner as a conventional retractable leash. During use, a handler may select to actuate the safety locking mechanism 185 in certain situations. For example, a handler may actuate the safety locking mechanism 185 when the lead 115 is extended from the housing 135 at a particularly desirable length for a particular situation, and the handler desires more secure locking of the length of the lead 115 than would be provided by the retraction control mechanism 180 alone. A handler may also select to actuate the safety locking mechanism 185 when the handler anticipates an upcoming potentially reactive situation for the pet and/or a potentially dangerous situation, such as heavy traffic, especially when a large and/or active pet is being walked. When there is no potentially reactive or dangerous situation, the handler can keep the safety locking mechanism 185 in the unactuated position 200 or can move the safety locking mechanism 185 from the actuated position 205 back to the unactuated position 300 so the leash can be returned to its normal operation where the lead retraction mechanism 175 is controlled by the retraction control mechanism 180. To move the safety locking mechanism 185 from the actuated position 205 to the unactuated position 200, the button 195 of the actuator 190 can be returned from the position of FIG. 2B to the position of FIG. 2A. Optionally, a tab or the like can be provided on the button 195 to facilitate the movement. In an alternative version, the button positions can be reversed so that the button position shown in FIG. 2A is associated with the safety locking mechanism 185 being in an actuated position 205, and the button position shown in FIG. 2B is associated with the safety locking mechanism 185 being in an unactuated position 200.

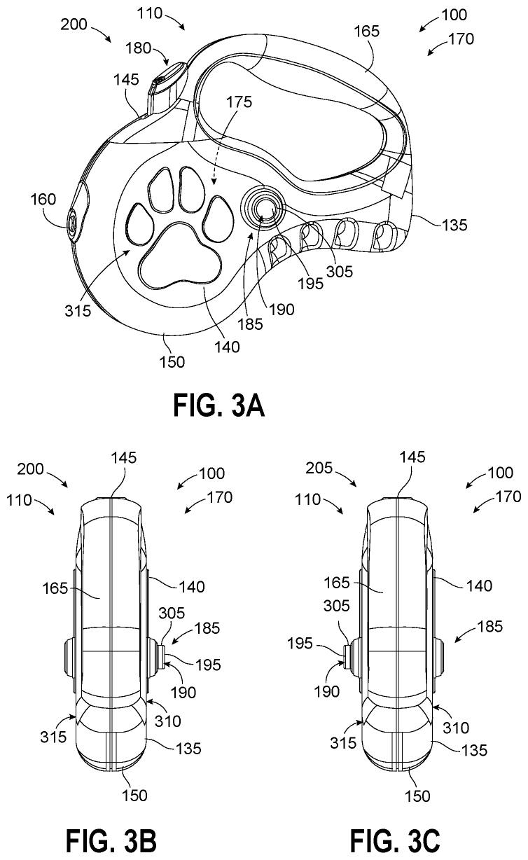

FIGS. 3A, 3B, and 3C show a version of a pet leash that is similar to the version of FIGS. 1, 2A, and 2B. In the version of FIGS. 3A, 3B, and 3C is designed to easily facilitate the movement of the safety locking mechanism 185 from the unactuated position 200 to the actuated position 205 and back to the unactuated position 200. In this version, the button 195 of the actuator 190 is a cross member 305 that extends across the width of the housing 135 from a right side surface 310 to a left side surface 315. FIGS. 3A and 3B show the cross member 305 of the button 195 extending to the right so that it protrudes from the right side surface 310 more than from the left side surface 315. In this position, the safety locking mechanism 185 is in its unactuated position 200. To move the safety locking mechanism to its actuated position 205, pressure is applied to the cross member 305 on the right side of the cross member 305 to cause the cross member 305 to slide to the position shown in FIG. 3C where it now extends to the left so that it protrudes from the left side surface 315 more than the right side surface 310. In the position of FIG. 3C, the safety locking mechanism 185 is in its actuated position 205. To then return the safety locking mechanism 185 to its unactuated position 200, the cross member 305 is moved back to the right by applying pressure to the left side of the cross member 305. In this manner, the safety locking mechanism 185 can be easily toggled back and forth between the unactuated position 200 and the actuated position 205. In an alternative version, the cross member positions can be reversed so that the cross member position shown in FIGS. 3A and 3B is associated with the safety locking mechanism 185 being in an actuated position 205, and the cross member position shown in FIG. 3C is associated with the safety locking mechanism 185 being in an unactuated position 200.

The safety locking mechanism 185 operates by directly contacting the lead 115 within the interior space 155 of the housing 135 and/or by contacting or otherwise engaging a component within the interior space 155 of the housing that is associated with the extension and/or retraction of the lead 115 from or into the housing 135. For example, in one version, the safety locking mechanism 185 operates as a secondary or additional locking mechanism to a locking or braking feature of the retraction control mechanism 180 by directly pressing, pulling, pushing, and/or grabbing the lead 115. In another version, the safety locking mechanism 185 operates as a secondary or additional locking mechanism to a locking or braking feature of the retraction control mechanism 180 by engaging a portion of the lead retraction mechanism 175 when the safety locking mechanism 185 is in its actuated position 205. In yet another version, the safety locking mechanism 185 operates as the locking mechanism for the pet leash 100 in place of a locking feature of the retraction control mechanism 180.

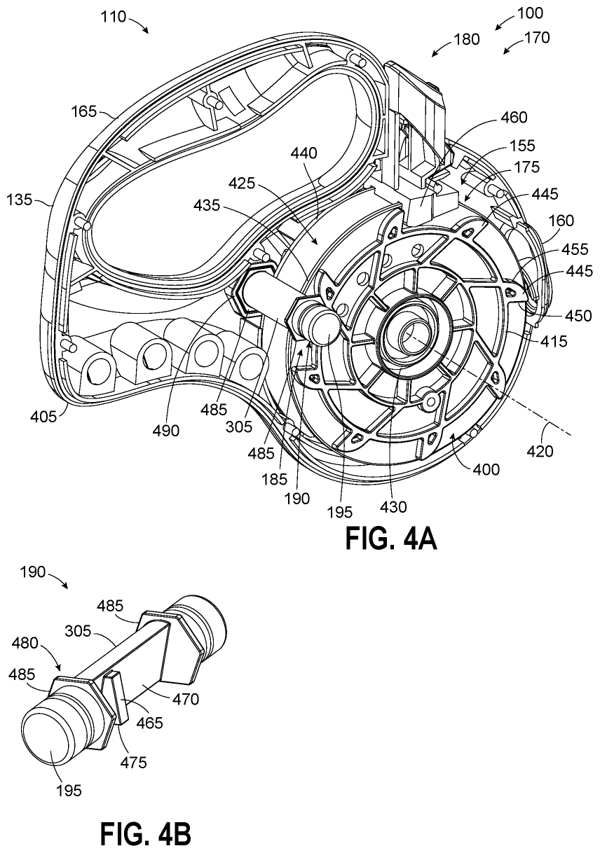

FIG. 4A shows a version of a pet leash 100 of the invention in which the pet leash 100 includes a lead retraction mechanism 175 which includes a spooling mechanism 400 controlled by the retraction control mechanism 180. In the version of FIG. 4A, the housing 135 is made up of a left casing 405 and a right casing 410 with the right casing 410 removed from the view so the interior space 155 can be more clearly illustrated. Similarly, the pet tethering portion 105 of the pet leash is not shown in FIG. 4A for clarity. The spooling mechanism 400 serves to allow the pet leash 100 to operate as a retractable pet leash 170 in a generally conventional manner when the safety locking mechanism 185 is in an unactuated position 200, as is the case for FIG. 4A. The spooling mechanism 400 includes a circular spool member 415 that rotates about a spool axis 420. A lead-receiving channel 425 is provided on the radial periphery of the spool member 415 and is sized and shaped to receive the lead 115 in a spooling manner. The lead 115, when present, extends from the lead opening 160 over the top of the spooling member 415 within the channel 425 so that the lead 115 can be retracted by counterclockwise rotation of the spooling member 415 with respect to the view of FIG. 4A and can be extended by clockwise rotation of the spooling member 415 with respect to the view and the version of FIG. 4A. The rotational direction of spooling member 415 can be switch by, for example, wrapping the lead 115 around the bottom of the spooling member 415. The spool member 415 is biased in the counterclockwise rotational direction by a coil or torsion spring, not shown, positioned in a central recess 430 in the spooling member 415. Optionally, a first channel wall 435 and a second channel wall 440 extend radially and circumferentially around the spooling member 415 to help secure the lead 115 within the channel 425. One or more projections 445 extend radially at or near the outer radial periphery of the spooling member 415. The projections 445 are asymmetric and include a contact surface 450 on one side and a sloped surface 455 on an opposite side. The retraction control mechanism 180 is selectively moveable relative to the top 145 of the housing 135 and in a radial direction relative to the spooling member 415 to move a blocking member 460, which may include one or more moveable members, into engagement with the spooling member 415 to control the spooling thereof. When moved radially inward toward the spool axis 410, the blocking member 450 is in a position to contact the contact surface 440 of one of the projections 435 so as to prevent clockwise rotation of the spooling member 405 and thus prevent extension of the lead 115 out of the housing 135. The retraction control mechanism 180 may also include a braking member that brakes rotation of the spooling member 405 by friction and/or by engaging the sloped surface 445 on a projection 435. In the version of FIG. 4A, the safety locking mechanism 185 is an additional, secondary, and/or stand-alone lock that when actuated engages the spooling mechanism 400 in a manner that prevents rotation of the spool member 415 and thus prevents extension of the lead 115 away from the housing 135.

FIG. 4B shows a version of an actuator 190 that can be used with the pet leash of FIG. 4A to actuate and unactuated the safety locking mechanism 185. In this version, the safety locking mechanism 185 comprises a stop member 465 positioned on a spool-facing side 470 of the cross member 305 of the actuator 190. In the unactuated position of FIG. 4A, the actuator 190 and cross member 305 are moved to the right to a position where the stop member 465 does not engage the spool member 415 in a locking relationship. By pressing on the button 195 to move the actuator to the left, the cross member 305 slides laterally relative to the spool member 415 to a position where a catch surface 475 of the stop member 465 contacts a contact surface 450 of a projection 445 of the spool member 415 thereby preventing the spool member 415 from rotating clockwise thus preventing extension of the lead 115 from the housing 135. The safety locking mechanism 185 can then be unactuated by moving the actuator back to the right and the position shown in FIG. 4A where the stop member 465 is again out of engagement with the spool member 415 to allow the spool member 415 to rotate in normal operation.

The safety locking mechanism 185 of the version of FIG. 4 and other similar versions improves the safety of operation of the pet leash 100. For example, In addition, by having a separately and independently actuatable safety locking mechanism 185 from the retraction control mechanism 180, the safety locking ability of the safety locking mechanism 185 can be easily toggled back and forth from its unactuated position 200 to its actuated position 205 without concern for the operating position of the retraction control mechanism 180 thus allowing for a convenient and failsafe manner of locking the pet leach 100 in times of need for a handler. In addition, by applying a secondary lock that is operable in addition to the locking and/or braking feature of a conventional retraction control mechanism 180, the safety locking mechanism 185 serves as a backup lock in the event of failure of the retraction control mechanism 180.

Furthermore, the safety locking mechanism 185 can offer superior locking of the pet leash 100 over conventional locking features. For example, due to the direction of movement and engagement of the safety locking mechanism 185, the lock provided can be more secure and/or robust that the locking feature of a conventional retraction control mechanism 180. The locking feature of a conventional retraction control mechanism 180 moves radially into engagement with a projection 445 of the spool member 415. When the blocking member 460 contacts a contact surface 450 and when the spool member 415 is blocked from rotating, the projection applies a circumferential force to the blocking member 460 which at least partially tends to urge the blocking member in its direction of movement towards a disengaged position. When the circumferential force of the blocked rotation gets sufficiently high, the locking or braking feature of the conventional retraction control mechanism 180 can fail and the spool member 415 can be free to rotate. In contrast, the movement of the safety locking mechanism 185 can be lateral to the spool member 415, such as by being in a direction parallel to the spool axis 420. When the safety locking mechanism 185 is actuated and engaged with the spool member 415, the spool member 415 does not apply force in the lateral direction or the direction of movement of the actuator 190. Since the actuator 190 is not designed to move in a direction where the spool member 415 is applying force, there is a decreased chance of failure and an increase in locking strength for the safety locking mechanism 185 when compared to a conventional locking feature of a retraction control mechanism 180.

The safety locking mechanism 185 can be made even more robust by a rotation prevention system 480, a version of which is shown in FIG. 4A, that prevents rotation of the actuator 190 that could lead to disengagement of the actuator 190 from the spool member 415. In the version of the rotation system 480 of FIG. 4A, a hexagonal member 485 that is rigidly connected to the cross member 305 of the actuator 190 is receivable within a hexagonally shaped recess 490 in the housing 135. In the particular version shown in FIG. 4A, the actuator 190 includes a pair of hexagonal member 485 that are each respectively received within a hexagonal recess in the left casing 405 and the right casing 410 of the housing 135.

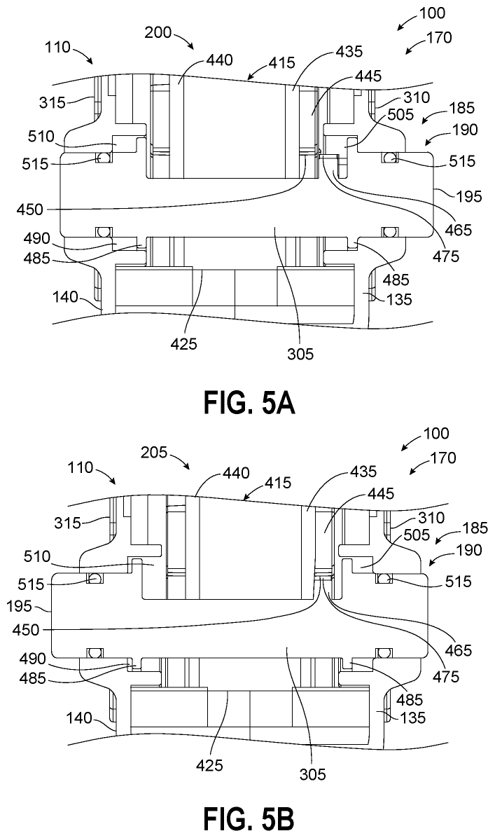

FIGS. 5A and 5B show sectional views through the actuator 190 and spool member 415 of the version of a pet leash 100 of FIGS. 4A and 4B in operation. FIG. 5A shows the safety locking mechanism 185 in an unactuated position 200 with the stop member 465 out of engagement with the spool member 415. FIG. 5B shows the safety locking mechanism 185 in its actuated position 205 with the actuator 190 moved so that the stop member 465 engages the contact surface 450 of a projection 445 of the spool member 415. As can also be seen in FIGS. 5A and 5B, the cross member 305 of the actuator 190 slides within a right side slide channel 505 and a left side slide channel 510 of the housing 135. One or more o-rings 515 or the like can optionally be provided to allow for a desired sliding action.

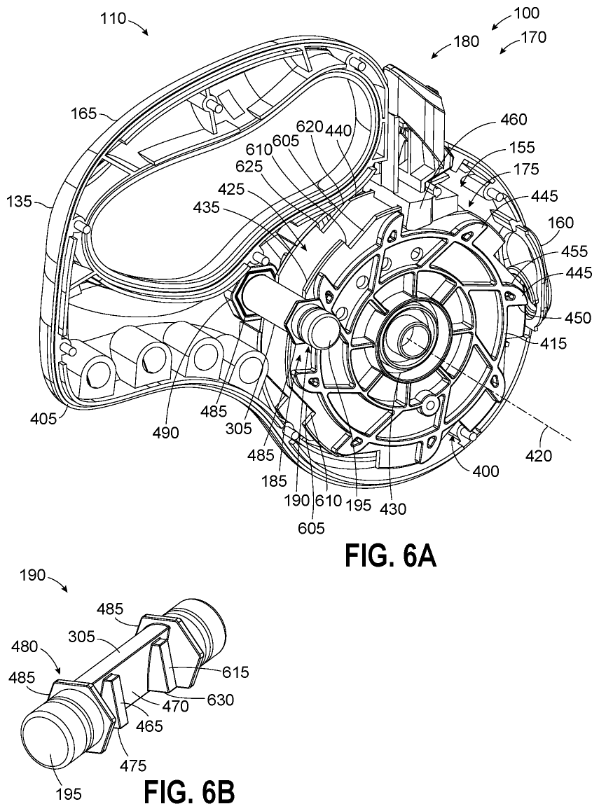

FIGS. 6A and 6B show another version of a pet leash 100 of the invention in which the pet leash 100 includes a lead retraction mechanism 175 which includes a spooling mechanism 400 controlled by the retraction control mechanism 180. The version of FIGS. 6A and 6B is similar to the version of FIGS. 4A and 4B, but in the version of FIGS. 6A and 6B, the safety locking mechanism 185 engages a portion of the spooling mechanism 400 other than one of the projections 445. In the version of FIGS. 6A and 6B one or more notches 605 are provided in or on the spool member 415. In the version of FIGS. 6A and 6B, the one or more notches 605 have a stop member engaging surface 610 so that the catch surface of the stop member 465 lockingly engages the stop member engaging surface 610 of the notch 605 to prevent rotation of the spool member 415 when the safety locking mechanism 185 is actuated. In the particular version of FIGS. 6A and 6B, the one or more notches are provided on the first channel wall 435. Optionally, a second stop member 615 can be provided on the actuator 190. In this version, one or more second notches 620 can be provided on the second channel wall 440. The one or more second notches 620 each have a second stop member engaging surface 625 that can be engaged by a second stop member catch surface 630 on the second stop member 615. The version of the safety locking mechanism 185 of FIGS. 6A and 6B provides added security by providing two locking contact points and also provides the benefit of using a locking surface other than a surface on a projection 445 that is being use for the retraction control mechanism 180. This reduces the wear on the projections 445 and provides a backup locking system in the event of breakage of the projections 445.

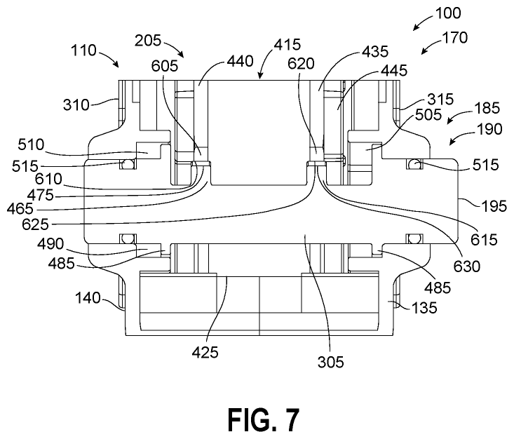

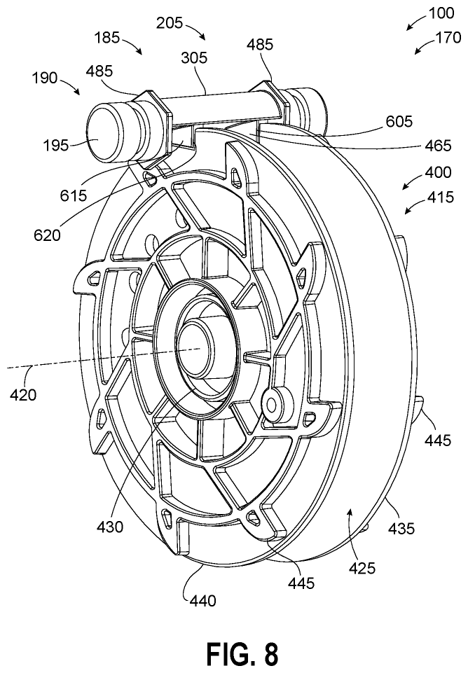

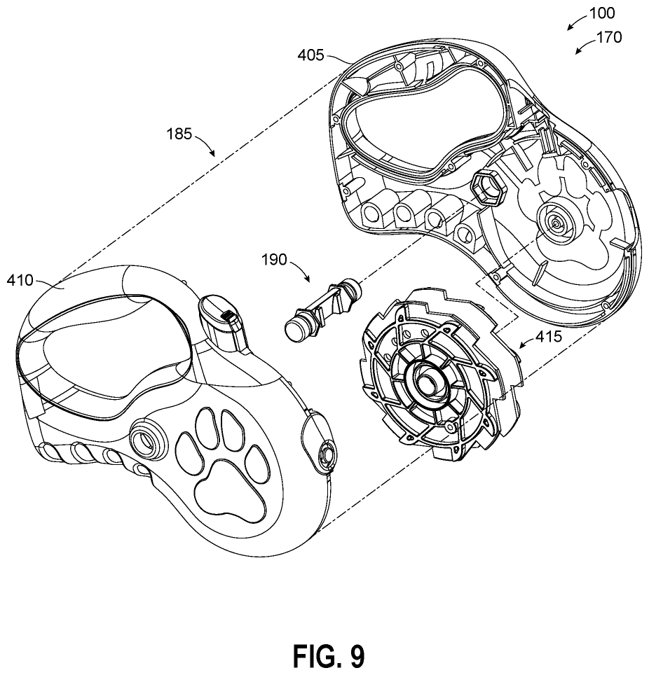

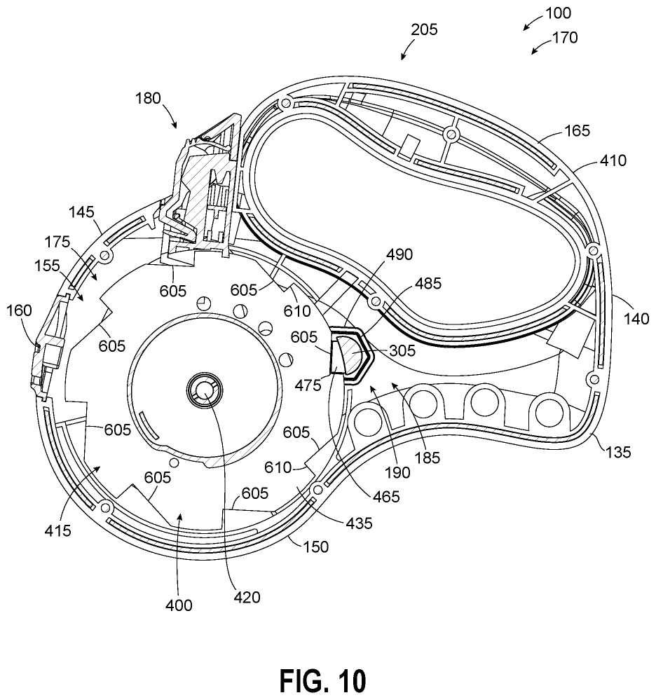

FIG. 7 shows a sectional view through the actuator 190 and spool member 415 of the version of a pet leash 100 of FIGS. 6A and 6B in operation. FIG. 7 shows the safety locking mechanism 185 in its actuated position 205 with the actuator 190 moved so that the stop member 465 engages the engaging surface 610 of the notch 605, and the second stop member 615 engaged the second member engaging surface 625. FIG. 8 shows another of the safety locking mechanism 185 of the version of FIGS. 6A and 6B in the actuated position 205 with only the actuator 190 and spool member 415 shown for clarity. FIG. 9 is an exploded view of the version of FIGS. 6A and 6B, and FIG. 10 is a sectional view from the left of the assembled version of FIGS. 6A and 6B.

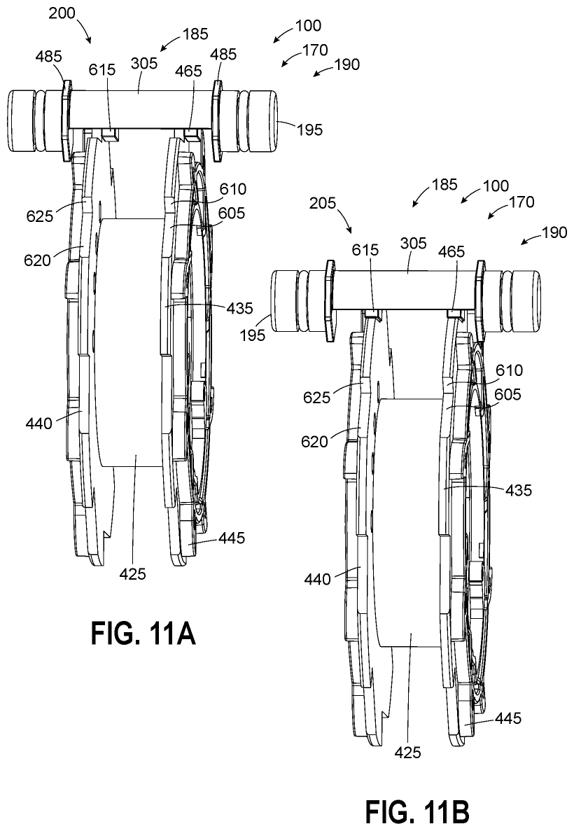

FIGS. 11A and 11B shows another version of a safety locking mechanism 185 of the pet leash 100 in the unactuated position 200 and the actuated position 205, respectively. The version of FIGS. 11A and 11B is similar to the version of FIGS. 6A and 6B, but the actuating motion has been switched so that movement from left to right causes actuation of the safety locking mechanism 185.

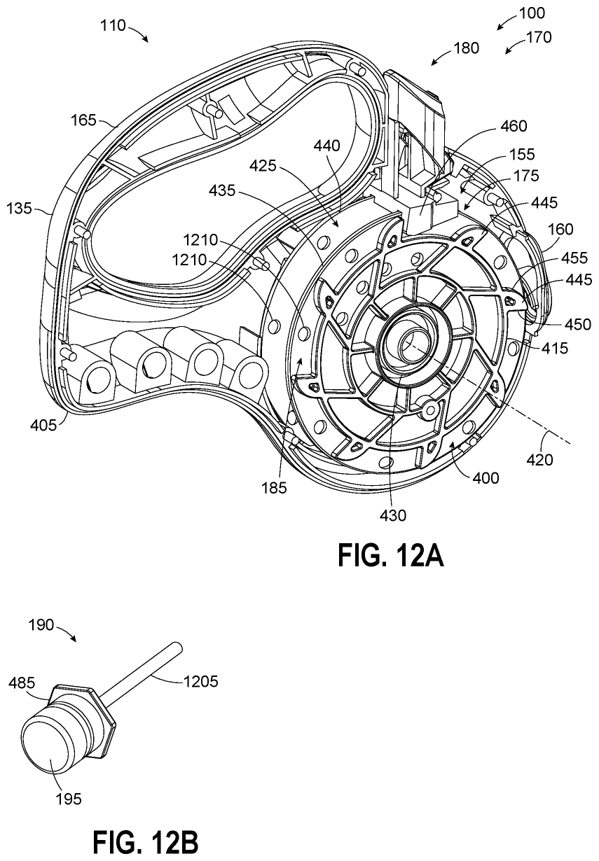

FIGS. 12A and 12B show another version of a pet leash 100 of the invention in which the pet leash 100 includes a lead retraction mechanism 175 which includes a spooling mechanism 400 controlled by the retraction control mechanism 180. The version of FIGS. 12A and 12B is similar to the version of FIGS. 4A and 4B, but in the version of FIGS. 12A and 12B, the safety locking mechanism 185 comprises the actuator 190 a rod member that is aligned with and selectively insertable into one of one or more apertures 1210 provided on the spool member 415. In the particular version of FIGS. 12A and 12B, the one or more apertures 1210 are provided around the periphery of the first channel wall 435 and/or the second channel wall 440. To actuate the safety locking mechanism 185 of the version of FIGS. 12A and 12B, the rod member 1205 is inserted into one or a pair of apertures 1210 to thereby prevent rotation of the spool member 415.

As discussed above, in one version, the pet leash 100 of the present invention can include both a primary locking mechanism, such as a conventional locking feature of a retraction control mechanism 180, and a safety locking mechanism 185 as described herein that operates as a secondary safety mechanism within the housing 135 to improve the overall safety and control during pet walks. Alternatively, the safety locking mechanism 185 in its various versions described herein can serve as the primary locking feature for the pet leach 100 or can serve as a stand alone locking mechanism for the pet leash 100. In one particular version, the retraction control mechanism 180 can serve to control the braking and/or retraction of the lead 115 while the safety locking mechanism 185 serves as the primary or stand-alone lead extraction prevention or locking mechanism of the pet leash 100.

In other versions, the safety locking mechanism 185 of the pet leash can use any other suitable locking mechanism. For example, the locking mechanism can use a different mechanism, such as one or more of, but not limited to: a pawl and ratchet mechanism, a friction brake mechanism, a magnetic locking mechanism, a torsion spring mechanism, a gear-based locking mechanism, and the like. For example, a pawl and ratchet mechanism can incorporate a toothed bar or wheel the pawl that engages with the ratchet to restrict movement in one direction. The pawl prevents the lead from extending further when the dog applies sudden force, ensuring instant control and safety. A friction brake mechanism can incorporate a friction brake within the leash casing, the mechanism creates resistance against the leash rope or tape, effectively preventing it from extending rapidly in response to sudden movements. In one particular example, the friction can be applied by a laterally moving actuator moving in a direction parallel to the spool axis 420 as discussed above. Adjusting the friction allows for customized control and responsiveness based on the specific needs of the dog and the owner. A magnetic locking mechanism can utilize magnets within the housing 135. This mechanism employs magnetic attraction to secure the lead 115, preventing rapid extension or release. The strength of the magnets can be calibrated to provide the necessary resistance while allowing for swift and effortless disengagement when required. A torsion spring mechanism can utilize the torsion generated by a coiled spring to restrict the rotation of the leash reel, thus controlling the leash's extension during sudden or forceful movements. The spring's tension can be adjusted to accommodate different dog sizes and strengths, providing a reliable and adaptable locking solution. A gear-based locking mechanism can incorporate gears within the housing 130. This mechanism enables the engagement of interlocking teeth or cogs to restrict the extension of the leash. The gear system ensures a secure and robust locking mechanism that effectively responds to sudden dog movements, enhancing control and safety during walks. Any of these safety locking mechanism alternatives can be used in place of any of the above version or one or more of these variations can be used along with or in conjunction with any of the versions described herein.

The dog leash 100 of the invention can be constructed using durable and lightweight materials, including high-strength polymers, reinforced metals, and weather-resistant textiles, ensuring robustness and longevity in various outdoor conditions. The materials used in the construction of the dog leash apparatus may be treated with weather-resistant coatings and finishes, rendering the apparatus resistant to moisture, UV radiation, and temperature fluctuations, thereby ensuring durability and functionality in diverse outdoor environments and weather conditions. The housing 115 is designed to accommodate standard leash dimensions, with variations available to suit different dog sizes and breeds. The overall dimensions typically range from 6 inches to 12 inches in length, 4 inches to 8 inches in width, and 2 inches to 4 inches in thickness, ensuring a compact and ergonomic design for user convenience.

The dog leash 100 of the present invention thus satisfies the need for an improved dog leash since many dog/pet owners have the issue with their dogs/pets breaking the current locking mechanisms. This is especially true for bigger dogs that are strong and able to run with force.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A pet leash comprising:
a housing comprising sidewalls, a bottom, and a top that define an interior space, the housing having a graspable member adapted to be grasped by a handler;
a lead comprising a length of material extending from a pet connecting member to a housing end of the lead, the housing end of the lead being received within the interior space of the housing;
a lead retraction mechanism associated with the housing and adapted to allow the lead to be retracted into the housing or extended from the housing;
a retraction control mechanism adapted to control the lead retraction mechanism to allow a handler to selectively control the retraction into and extension from the housing of the lead to selectively adjust the length of the lead extending from the housing; and
a safety locking mechanism associated with the housing and adapted to be in an unactuated position where the lead retraction mechanism operates under the control of the retraction control mechanism and in an actuated position where the safety locking mechanism prevents extension of the lead from the housing.

2. A pet leash according to claim 1 wherein the safety locking mechanism comprises an actuator moveable relative to the housing to cause the safety locking mechanism to move from the unactuated position to the actuated position.

3. A pet leash according to claim 1 wherein the safety locking mechanism comprises an actuator moveable relative to the housing to cause the safety locking mechanism to move from the unactuated position to the actuated position and from the actuated position to the unactuated position.

4. A pet leash according to claim 1 wherein the safety locking mechanism comprises an actuator moveable relative to the housing to cause the safety locking mechanism to move from the unactuated position to the actuated position, and wherein the actuator is moveable in a direction orthogonal to a direction of extension of the lead out of the housing.

5. A pet leash according to claim 1 wherein the lead retraction mechanism comprises a spooling mechanism, the spooling mechanism comprising:
a spool member that is rotatable about a spool axis, the spool member having a lead receiving channel adapted to receive the lead in a spooling manner,
a spring adapted to bias the rotating spool member in a rotational direction that retracts the lead into the housing, and
one or more radially extending projections near the circumferential periphery of the rotatable spool member.

6. A pet leash according to claim 5 wherein when the safety locking mechanism is in the actuated position, the safety locking mechanism engages the spool member in a manner that prevents rotation of the spool member.

7. A pet leash according to claim 5 wherein when the safety locking mechanism is in the actuated position, the safety locking mechanism engages the one or more projections of the spool member in a manner that prevents rotation of the spool member.

8. A pet leash according to claim 5 wherein the safety locking mechanism comprises an actuator moveable relative to the housing to cause the safety locking mechanism to move from the unactuated position to the actuated position, wherein movement of the actuator causes a stop member to be moved into a position where the stop member engages the pool member in a manner that prevents rotation of the spool member.

9. A pet leash according to claim 5 wherein the safety locking mechanism comprises an actuator moveable relative to the housing to cause the safety locking mechanism to move from the unactuated position to the actuated position, wherein movement of the actuator causes a stop member to be moved into a position where the stop member engages the pool member in a manner that prevents rotation of the spool member, and wherein the stop member is on a cross member of the actuator that extends from a right side of the housing to a left side of the housing.

10. A pet leash according to claim 5 wherein the safety locking mechanism comprises an actuator moveable relative to the housing to cause the safety locking mechanism to move from the unactuated position to the actuated position, wherein movement of the actuator causes a stop member to be moved into a position where the stop member engages the pool member in a manner that prevents rotation of the spool member, and wherein the stop member is moved in a direction parallel to the spool axis.

11. A pet leash according to claim 5 wherein the retraction control mechanism controls the rotation of the spool member.

12. A pet leash according to claim 5 wherein the retraction control mechanism controls the rotation of the spool member and includes a locking feature that prevents rotation of the spool mechanism.

13. A pet leash according to claim 1 wherein the safety locking mechanism comprises an actuator manually moveable relative to the housing to cause the safety locking mechanism to move from the unactuated position to the actuated position.

14. A pet leash comprising:
a housing comprising sidewalls, a bottom, and a top that define an interior space, the housing having a graspable member adapted to be grasped by a handler;
a lead comprising a length of material extending from a pet connecting member to a housing end of the lead, the housing end of the lead being received within the interior space of the housing;
a lead retraction mechanism associated with the housing and adapted to allow the lead to be retracted into the housing or extended from the housing, the lead retraction mechanism comprising a spooling mechanism, the spooling mechanism comprising:
a spool member that is rotatable about a spool axis, the spool member having a lead receiving channel adapted to receive the lead in a spooling manner, and
a spring adapted to bias the rotating spool member in a rotational direction that retracts the lead into the housing, and
a safety locking mechanism associated with the housing and adapted to be in an unactuated position where the lead can be extended from the housing and in an actuated position where the safety locking mechanism prevents of the lead from being extended from the housing,
wherein the safety locking mechanism comprises an actuator moveable relative to the housing in a direction parallel to the spool axis to cause the safety locking mechanism to move from the unactuated position to the actuated position.

15. The pet leash according to claim 14 wherein the actuator comprises a stop member that engages the spool member in a manner that prevents the spool member from rotating when the safety locking mechanism is in the actuated position.

16. The pet leash according to claim 14 wherein the spool member comprises one or more radially extending projections near the circumferential periphery of the spool member and wherein the actuator comprises a stop member that engages the one or more projections of the spool member in a manner that prevents the spool member from rotating when the safety locking mechanism is in the actuated position.

17. The pet leash according to claim 14 wherein the pet leash further comprises a retraction control mechanism adapted to control the lead retraction mechanism to allow a handler to selectively control the retraction into and extension from the housing of the lead to selectively adjust the length of the lead extending from the housing, wherein the retraction control mechanism and the safety locking mechanism are independent from one another.

18. The pet leash according to claim 14 wherein the pet leash further comprises a retraction control mechanism adapted to control the lead retraction mechanism to allow a handler to selectively control the retraction into and extension from the housing of the lead to selectively adjust the length of the lead extending from the housing, wherein the retraction control mechanism comprises a locking feature that prevents rotation of the spool member.

19. A method of walking a pet on a leash, the method comprising:
providing a pet leash comprising:
a housing comprising sidewalls, a bottom, and a top that define an interior space, the housing having a graspable member adapted to be grasped by a handler;
a lead comprising a length of material extending from a pet connecting member to a housing end of the lead, the housing end of the lead being received within the interior space of the housing;
a lead retraction mechanism associated with the housing and adapted to allow the lead to be retracted into the housing or extended from the housing;
a retraction control mechanism adapted to control the lead retraction mechanism to allow a handler to selectively control the retraction into and extension from the housing of the lead to selectively adjust the length of the lead extending from the housing; and
a safety locking mechanism associated with the housing and adapted to be in an unactuated position where the lead retraction mechanism operates under the control of the retraction control mechanism and in an actuated position where the safety locking mechanism prevents extension of the lead from the housing,
connecting the pet connecting member to a pet to be walked;
grasping the graspable member of the housing;
operating the retraction control mechanism to select a length of lead to extend from the housing; and
when desired, actuating the safety locking mechanism to prevent further extension of the lead from the housing.

20. A method according to claim 19 further comprising when desired, unactuating the safety locking mechanism to allow extension of the lead from the housing.
